(19) United States
(12) Patent Application Publication
(10) Pub. No.: US 2005/0138303 A1
(43) Pub. Date: Jun. 23, 2005

(54) Storage device

(76) Inventors: Hideki Nagino, Yokohama (JP); Tadashige Iwao, Kawasaki (JP); Masataka Kushigemachi, Yokohama (JP); Hideo Senkoushi, Yokohama (JP); Kazuaki Sumi, Yokohama (JP); Takayuki Okamasu, Yokohama (JP)

Correspondence Address: KATTEN MUCHIN ZAVIS ROSENMAN, 575 MADISON AVENUE, NEW YORK, NY, 10022-2585, US

(21) Appl. No.: 10/849,350

(22) Filed: May 19, 2004

(30) Foreign Application Priority Data
Dec. 19, 2003 (JP) 2003-423350

(51) Int. Cl. G06F 12/00

(52) U.S. Cl. 711/154; 711/163

(57) ABSTRACT

A storage device that is detachably attachable to an information processing apparatus, comprises an IC chip; a first control unit extracting a control command for the IC chip included in a control command for the storage device from the information processing apparatus; and a second control unit performing interface conversion corresponding to the IC chip on the control command for the IC chip extracted by the first control unit and giving the converted control command to the IC chip.

### BACKGROUND OF THE INVENTION

The present invention relates to a storage device with a built-in IC chip that is detachably attachable to an information processing apparatus such as a personal digital assistant (PDA), a personal computer (PC), or a mobile telephone. For instance, the present invention relates to a memory card with a built-in IC chip that is capable of providing an advanced security function as an authentication information source for various services such as log-in authentication, network connection authentication, and accounting.

Currently, there is a technology which is used to perform person authentication processing using an IC card or a memory card when a network connection is established. With such a technology, however, a dedicated card reader/writer for the IC card or the memory card is required, which leads to a lack-of-mobility problem. Also, it is impossible to encrypt information concerning the authentication processing, so that there is another problem that it is impossible to provide high security. Consequently, a high technology in mobility and security is desired.

As a prior art pertinent to the present invention, for instance, a storage device is known which has a first memory that is capable of storing data, a second memory that is capable of storing the data and performing security processing on the data, and a controller for selecting the first memory or the second memory based on a command from a host device, where a second command for the second memory is received from the host device while access from the host device to the first memory is being performed and processing is performed in accordance with the second command (see Patent document 1, for instance). FIG. 6 is an explanatory diagram of the storage device described in the Patent document 1.

Also, as another prior art relating to the present invention, a storage device is known which includes a nonvolatile memory, an IC, a controller for controlling access to the nonvolatile memory and the IC, and an interface that is shared by the nonvolatile memory and the IC through the mediation of the controller and establishes a connection with a host device, where the controller receives a first command from the host device, creates a second command interpretable by the IC from the first command received from the host device, and transmits the second command to the IC (see Patent document 2, for instance).

[Patent Document 1] JP 2003-22216 A

[Patent Document 2] JP 2003-91704 A

With the storage device described in the Patent document 1, however, a storage device (flash memory) for storing data and an IC chip that is capable of performing security processing are separately implemented in a memory card (see FIG. 6). Therefore, a controller for discriminating an access command transferred from a host side and selecting an access destination medium is required.

Also, with the storage device described in the Patent document 1, in order to perform access to the IC chip built in the memory card or the flash memory from the host side, the built-in controller first terminates a control command from the host side and then converts the command into a control command interpretable by the IC chip or the flash memory. Therefore, it is necessary for the controller to judge whether the control command is for the IC chip or for the flash memory. Consequently, a unique control command that is interpretable by the controller needs to be generated on the host side.

Further, with the storage device described in the Patent document 1, a dedicated driver for issuing such a unique command is required on the host side. Therefore, a driver that depends on the type of the memory card becomes necessary.

### SUMMARY OF THE INVENTION

The present invention is aimed at providing a storage device that is capable of controlling an IC chip built in the storage device using a control command for the storage device.

The present invention adopts the following construction to solve the above-mentioned problem. That is, according to the present invention, a storage device that is detachably attachable to an information processing apparatus, includes:
an IC chip;
a first control unit for extracting a control command for the IC chip included in a control command for the storage device from the information processing apparatus; and
a second control unit for performing interface conversion corresponding to the IC chip on the control command for the IC chip extracted by the first control unit and gives the converted control command to the IC chip.

According to the present invention, when the control command is given to the storage device from the information processing apparatus, the first control unit extracts a control command for the IC chip contained in the control command. The second control unit performs interface conversion on the control command for the IC chip extracted by the first control unit and gives the converted control command to the IC chip.

According to the present invention, it becomes possible for the information processing apparatus to control the IC chip built in the storage device by issuing a control command for the storage device. That is, a unique control command for controlling the IC chip is unnecessary. As a result, a writer for the IC chip is unnecessary.

It is preferable that the storage device has portability. Also, it is more preferable that a card-type storage medium is used as the storage device. For instance, it is preferable that a PC card or a small-sized memory card (SD memory card, for instance) is used.

Preferably, the second control unit of the present invention performs interface conversion of data sent from the IC chip and stores the converted data in a predetermined storage area, and
the first control unit of the present invention reads the data stored in the storage area in accordance with a control command for the storage device from the information processing apparatus and gives the read data to the information processing apparatus.

With this construction, it is possible for the information processing apparatus to read data sent from the IC chip (response data corresponding to a control command, for instance) from the storage device. As a result, it is possible for the information processing apparatus to read from the storage device data sent from the IC chip without using a unique command or a reader for the IC chip.

Also, the first control unit of the present invention preferably receives a writing command for the storage apparatus, in whose data area a control command for the IC chip is mapped, and extracts the control command for the IC chip mapped in the data area.

Also, the first control unit of the present invention preferably refers to an address area of the writing command for the storage device and, when an address is set therein which shows that the control command for the IC chip is mapped in the data area, extracts the control command for the IC chip from the data area.

Also, the IC chip of the present invention preferably includes a nonvolatile memory and has a security function. In this way, the IC chip is constructed to function as the data storage device and the security device, thus achieving simplification of the construction in the storage device.

### DESCRIPTION OF THE DRAWINGS

FIG.1 is a functional block diagram showing an example of a construction of a memory card with a built-in IC chip according to the present invention.

FIG.2 is a diagram showing the outline of a sequence for controlling the built-in IC chip.

FIG.3 is a diagram showing the outline of a sequence for receiving a response from the built-in IC chip.

FIG.4 is a diagram showing an example of a usage form of the memory card with the built-in IC chip.

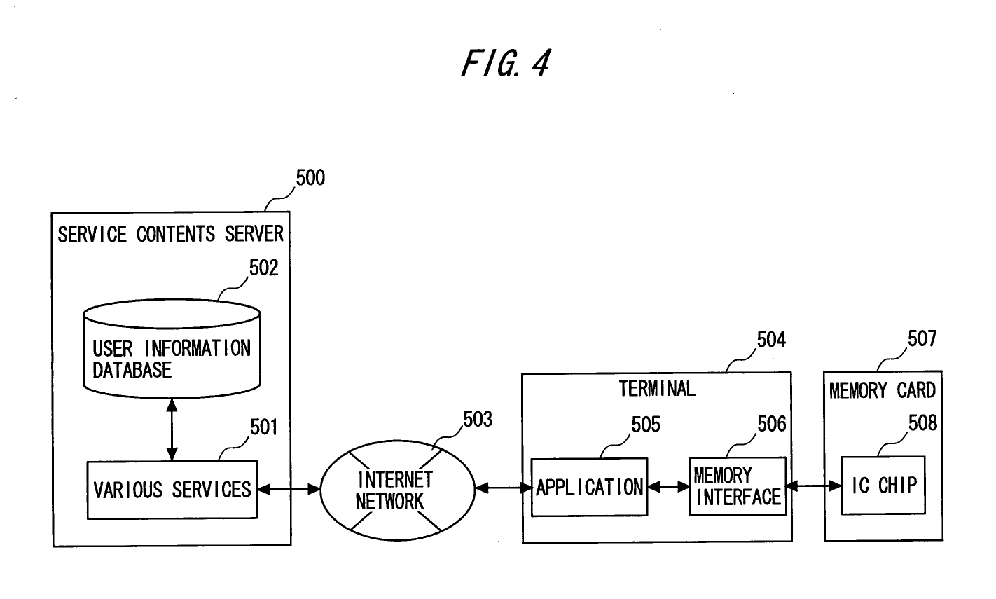

FIG.5 is a diagram showing an access processing flow in the usage form example of the memory card with the built-in IC chip.

FIG.6 is an explanatory diagram of a prior art.

### DETAILED DESCRIPTION OF THE INVENTION

An embodiment of the present invention is explained with reference to the drawings below. A construction of the embodiment is an example and a construction of the present invention is not limited to the construction of the embodiment.

<Construction>

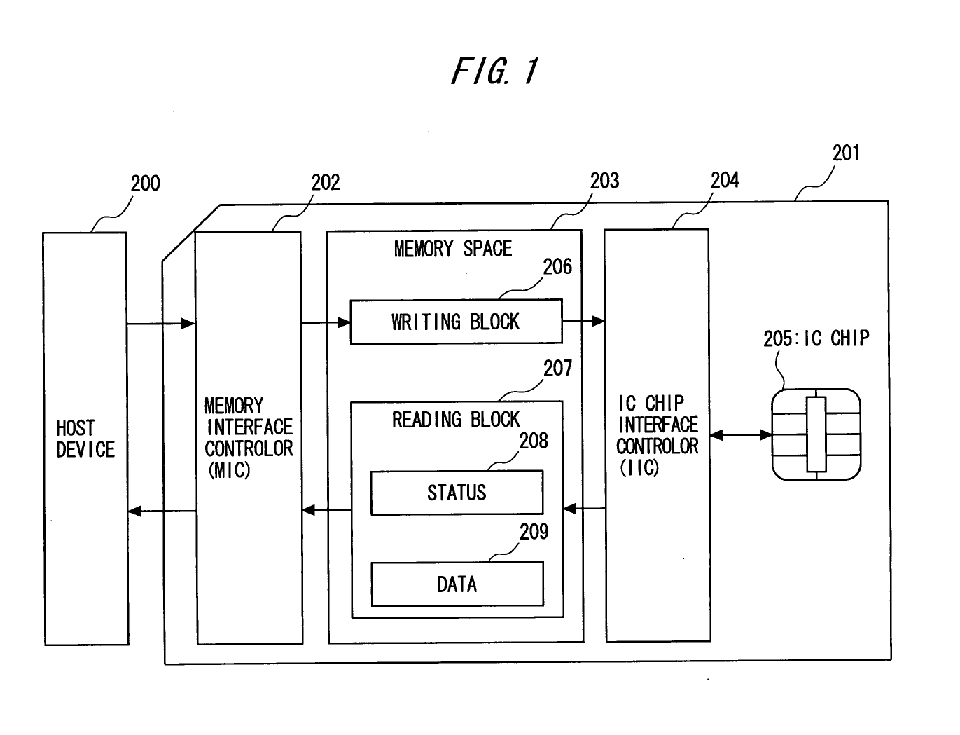

FIG. 1 shows an example of an internal construction of a storage device in the embodiment of the present invention. In FIG. 1, the storage device is a memory card with a built-in IC chip (hereinafter simply referred to as the “memory card”) 201 that has a physical interface pursuant to a standard for a memory card such as an SD memory card, is electrically connected to a memory interface of a host device 200, and is capable of receiving and interpreting a control command pursuant to the memory card standard.

The host device 200 is an information processing apparatus, such as a personal digital assistant (PDA), a personal computer (PC), or a mobile telephone, and has a card slot for mounting the memory card 201. The memory card 201 is inserted into the card slot and is connected to the memory interface provided in the slot. Under this state, the memory card 201 functions as one of apparatuses under control by the host device 200.

As shown in FIG. 1, the memory card 201 has a nonvolatile memory and a security function (which can include an authentication function and an encryption/decryption function), and includes: an IC chip 205 having a unique physical interface; a memory interface controller (MIC) 202 (corresponding to a first control unit) that interprets a control command for the memory card 201 from the host device 200 and, if a control command for the IC chip 205 is contained in the control command, extracts the control command for the IC chip 205; an IC-chip interface controller (IIC) 204 (corresponding to a second control unit) that acquires the control command for the IC chip 205 extracted by the MIC 202, converts the control command into a format corresponding to the physical interface of the IC chip 205 (format in which the IC chip 205 is capable of dealing with the command), and gives the converted control command to the IC chip 205; and a memory space 203 used to perform exchange of data between the MIC 202 and the IIC 204.

The memory space 203 has a writing block 206, in which data that should be transferred from the MIC 202 to the IIC 204 (such as a control command for the IC chip) is stored, and a reading block 207 (corresponding to a storage area) in which data sent from the IC chip and information concerning this data are stored. Also, areas provided in the reading block 207 are a data storage area 209 for storing data sent from the IC chip 205 (response data corresponding to a control command, for instance) and a flag storage area 208 for storing a flag showing the status (valid/invalid) of the data stored in the storage area 209.

As described above, the IC chip 205 is given both of the nonvolatile memory (functioning as a data storage device) and the security function, thereby achieving simplification of the interface in the memory card 202.

The host device 200 is constructed so as to be capable of controlling the IC chip 205 built in the memory card 201 by giving a control command for the memory card containing a control command for the IC chip to the memory card 201.

That is, the host device 200 has an application for issuing a control command for the memory card 201 in whose data area a control command for the IC chip 205 is mapped. After the application generates data concerning the control command for the memory card 201, a driver circuit for the memory card 201 possessed by the host device 200 generates a control command signal with a signal format corresponding to the memory card 201 from the data concerning the control command. Then, the control command signal is received (inputted) into the memory card 201 through the memory interface.

Here, it becomes necessary for the application to have new functions for designating an address with respect to the memory card 201 and mapping of the performing of the control command for the IC chip. As to the driver circuit for creating the control command for the memory card 201, however, it is possible to use an already-existing driver circuit for creating a control command for a memory card as it is.

The MIC 202 receives such a control command from the host device 200 and transfers a control command for the IC chip 205 mapped in the control command to the IIC 204 through the writing block 206 of the memory space 203.

The IIC unit 204 performs interface conversion on the transferred control command and gives the converted control command to the IC chip 205. With this construction, it is possible for the host device 200 to give a control command to the IC chip 205 and to control the IC chip 205. Through the control of the IC chip 205, the host device 200 performs data writing/reading with respect to the nonvolatile memory possessed by the IC chip 205, execution of a security function, and other operations.

Also, data sent from the IC chip 205 (response data corresponding to a control command, for instance) is stored in the reading block 207 of the memory space 203 through the IIC 204. If a reading command (one type of control commands) for the memory card 201 is received from the host device 200, the MIC 202 reads valid data placed in the reading block 207 and gives the read data to the host device 200. With this construction, it is possible for the host device 200 to receive response data (response) from the IC chip 205.

### OPERATION EXAMPLE

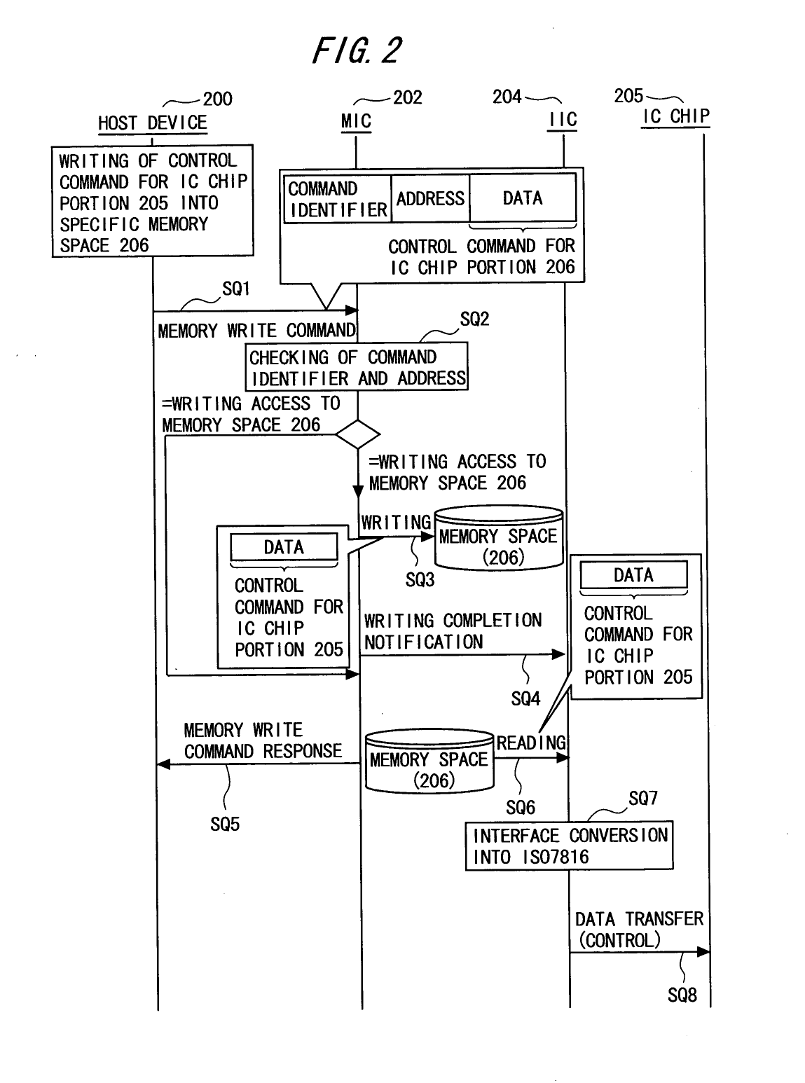

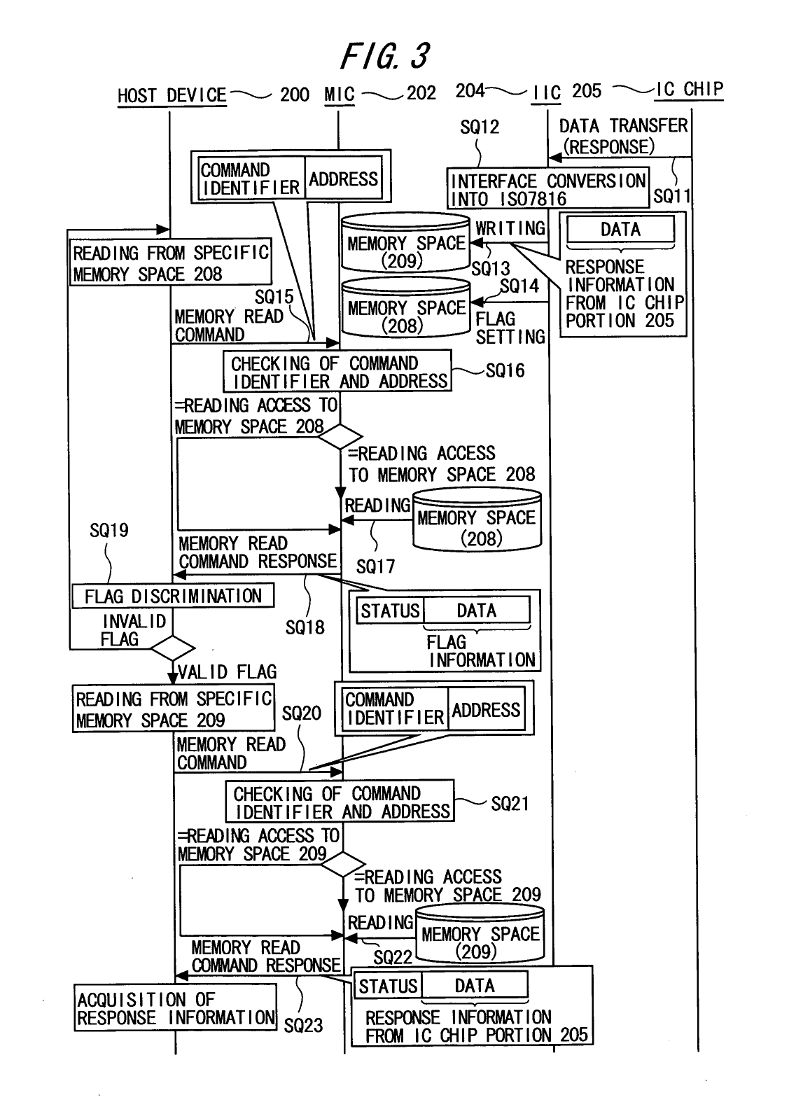

FIG. 2 shows a sequence for controlling the IC chip 205 and FIG. 3 shows a sequence for receiving a response from the IC chip 205. In FIG. 2, a control sequence in the case where the host device 200 performs control of the IC chip 205 built in the memory card 201 is shown.

In order to perform control of the IC chip 205 using the application, the host device 200 issues a memory write command (writing command), which is one kind of control commands, to the memory card 201 through the memory interface.

The control command has areas for respectively storing a command identifier, an address, data, and a control command for the IC chip 205 is mapped in the data area.

The MIC 202 receives the memory write command from the host device 200 (SQ1). Then, the MIC 202 checks the command identifier and the address of the memory write command (SQ2) thereby discriminating whether the control command designates writing access to the specific memory space (writing block) 206.

Then, if the command identifier is set to “WRITE (writing)” and the address is set to a special address value that indicates writing access to the writing block 206 (indicating that a control command for the IC chip 205 is mapped), the MIC 202 discriminates that the writing access to the specific memory space 206 is designated; if not, the MIC 202 discriminates that the writing access to the specific memory space 206 is not designated.

If discriminating that the writing access to the specific memory space 206 is designated, the MIC 202 extracts a control command for the IC chip 205 mapped in the data area of the memory write command and writes the extracted control command into the specific memory space 206 (SQ3). When the writing is finished, the MIC 202 gives a writing completion notification to the IIC 204 (SQ4).

Then, the MIC 202 returns a response (memory write command response) corresponding to the memory write command to the host device 200 (application thereof) (SQ5). Note that when discriminating that the writing access to the specific memory space 206 is not designated, the MIC 202 merely returns a memory write command response to the host device 200.

If it received the writing completion notification from the MIC 202, the IIC 204 reads data stored in the specific memory space 206 (control command for the IC chip 205) (SQ6). Here, the IC chip 205 supports an interface pursuant to the ISO7816 standard, for instance. Therefore, the IIC 204 performs interface conversion on the data (control command) read from the specific memory space 206 into the ISO7816 standard (SQ7) and transfers the converted data to the IC chip 205 (SQ8). If it received the control command, the IC chip 205 performs an operation and processing corresponding to the received control command. In this manner, the host device 200 controls the IC chip 205.

FIG. 3 shows a sequence in the case where the IC chip 205 returns a response corresponding to the control command described above to the application of the host device 200. In FIG. 3, the IC chip 205 transfers data corresponding to the control command (response data) to the IIC 204 (SQ11).

If it received the response data, the IIC 204 converts the response data into a format in which it is possible to deal with this data on the host device 200 side (SQ12), writes the converted data into the data storage area 209 provided in the reading block 207 of the memory space 203 (SQ13), and sets a valid flag in the flag storage area (SQ14).

On the other hand, on the application side of the host device 200, periodical reading from the flag storage area (memory space) 208 is performed and it is discriminated whether a valid flag is set in the memory space 208.

That is, in order to read data from the memory space 208 using the application, the host device 200 issues a memory read command (reading command) through the memory interface and transmits it to the MIC 202 (SQ15).

If it received the memory read command, the MIC 202 checks the command identifier and the address contained in this control command (SQ16) and interprets the type and the contents of the control command.

Then, if the control command is discriminated as a memory read command that designates reading access to the memory space 208, the MIC 202 reads a flag from the memory space 208 (SQ17), generates a memory read command response containing this flag, and returns the generated memory read command response to the application of the host device 200 (SQ18).

If the control command is not the reading access to the memory space 208, the MIC 202 merely returns a memory read command response. In this case, all values of read data contained in the response are set to “0” (All “0”).

If it received the memory read command response, the application performs flag discrimination (SQ19). Then, if the flag is invalid, periodical reading processing of data from the memory space 208 is repeated.

In contrast to this, if the flag is valid, the application performs reading from the memory space (data storage area) 209. That is, the host device 200 issues a memory read command for reading data from the memory space 209 to the MIC 202 through the memory interface (SQ20).

If it received the memory read command, the MIC 202 checks the command identifier and the address of this command (SQ21) and discriminates whether the command designates reading access to the memory space 209.

Then, if the command designates the reading access to the memory space 209, the MIC 202 reads data (response data stored in SQ13) from the memory space 209 (SQ22), generates a memory read command response containing this data, and transmits it to the host device 200 (SQ23) In this manner, the application of the host device 200 acquires response data corresponding to the control command.

If the command is not the reading access to the memory space 209, the MIC 202 merely transmits a memory read command response to the host device 200. In this case, all values of read data contained in the response are set to “0” (All “0”)

### APPLICATION EXAMPLE

Next, an application example of the memory card 201 will be described. As the application example, a case will be described in which Internet access is performed using the memory card with the built-in IC chip described above and service contents on the Internet are used.

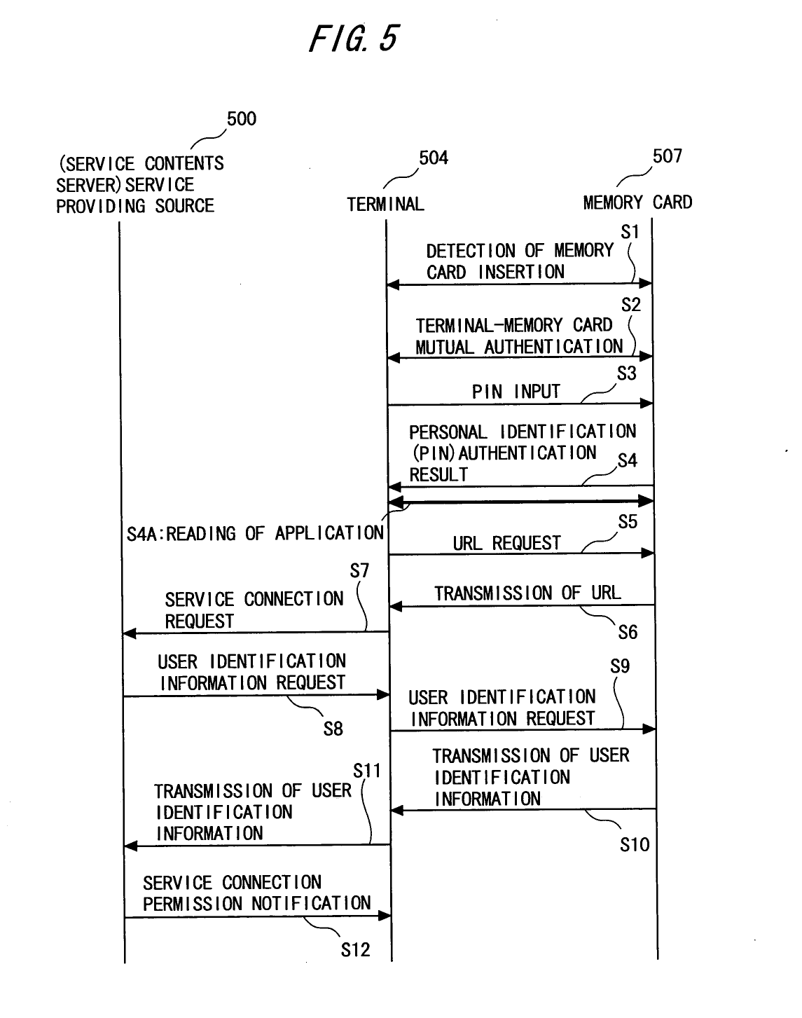

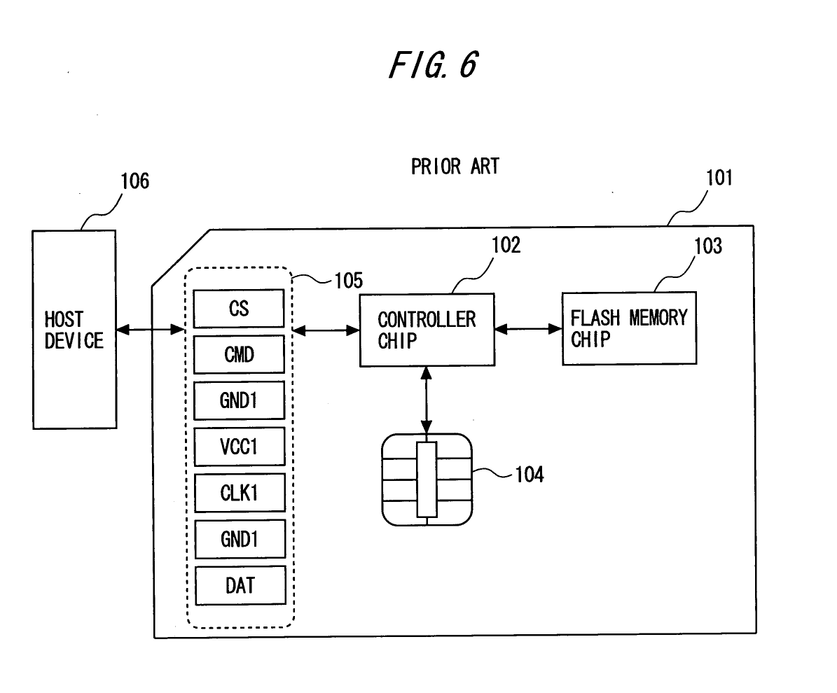

FIG. 5 is an explanatory diagram of a usage form (application example) of the memory card with the built-in IC chip and FIG. 6 is a sequence diagram showing an access processing flow in this application example. In FIG. 5, a terminal 504, to which a memory card 507 with a built-in IC chip 508 is detachably attachable, and a service contents server 500 are connected to each other through the Internet 503.

The service contents server 500 functions as an apparatus including a various service providing function 501 and a user information database 502. On the other hand, the terminal 504 functions as an apparatus including application 505 for accessing the service contents server 504 and receiving provision of a service and a memory interface 506 for controlling the IC chip 508 of the memory card with the built-in IC chip 507. The memory card 507 has the same construction as the memory card 201 shown in FIG. 2 and has the built-in IC chip 508 that includes a nonvolatile memory and has a security function.

Card information is stored in advance in the nonvolatile memory of the IC chip 508. The card information contains a uniform resource locator (URL) of the service contents server 500, user information on identification, and the like.

In order to use the contents of the service contents server 500 (hereinafter referred to as the “service providing source” 500), application of the service providing source 500 (application 505) for using the contents is stored in the nonvolatile memory of the IC chip 508. In this case, the card information, such as the URL of the service providing source and the user s identification information, may be stored in the IC chip 508 at the same time. Also, a user's public key is managed by the service providing source 500.

When the memory card 507 is inserted into a memory card slot of the mobile information terminal 504, the terminal 504 detects this insertion of the memory card 507 (S1 in FIG. 6) and performs terminal-memory card mutual authentication (S2).

When normally recognizing the memory card 507 through the mutual authentication, the terminal 504 performs reading processing of the application 505 existing in the nonvolatile memory in the IC chip 508. That is, in order to use the application 505, the terminal 504 inputs a personal identification number (PIN) into the IC chip 508 of the memory card 508 through the memory interface 506 (S3). Then, the IC chip 508 performs PIN authentication using a security function possessed by itself and returns a result of the authentication to the terminal 504 (S4).

When the PIN authentication has ended in success, the IC chip 508 shifts to a status where reading of the application 505 stored in the nonvolatile memory is permitted. Therefore, the terminal 504 reads the application 505 from the IC chip 508 (S4A) and installs it on itself. As a result, the terminal 504 shifts to a status where it is capable of requesting the service providing source 500 to provide a service by executing the application 505.

In order to access the service providing source 500 through the Internet 503, the user activates the application 505 read from the memory card 508 and installed on the terminal 504.

Then, the application 505 gives a URL request (URL reading command) from the terminal 504 to the memory card 507 (S5) In response to this request, the URL of the service providing source 500 stored in the nonvolatile memory in the IC chip 508 is transmitted from the memory card 507 to the terminal 508 (S6).

In this manner, the application 505 reads the URL of the service requesting source 500 from the IC chip 508. Next, the application 505 starts access to the service providing source 500 using the read URL. That is, the application 505 transmits a service connection request to the service requesting source 500 using the URL (S7)

If it received the service connection request, the service providing source 500 transmits a user identifier information request to the terminal 504 (S8) If it received the user identification information request, the application 505 of the terminal 504 gives reading command of user's identification information to the memory card 507 (S9).

In response to this reading command, the IC chip 508 of the memory card 507 reads the user s identification information stored in the nonvolatile memory, performs encryption processing on the user's identification information using pre-stored user's secret key, and outputs the encrypted user's identification information, which is then transmitted from the memory card 507 to the terminal 504 (SlO).

It should be noted here that at the time of storage of the user's identification information, the IC chip 508may encrypt the user's identification information using the secret key before storing it in the nonvolatile memory. In this case, the IC chip 508 merely reads the encrypted user's identification information from the nonvolatile memory and outputs it in accordance with the reading command.

After receiving the encrypted user's identification information read from the IC chip 508, the application 505 of the terminal 504 transmits it to the service requesting source 500 (S11).

After receiving the encrypted user's identification information, the service providing source 500 decrypts the encrypted user's identification information using a pre-stored user's public key and confirms whether the decrypted user's identification information is information from the user himself/herself (whether the user's identification information is correct) through matching processing based on information accumulated in the user information database 502.

Then, if judging that the user's identification information is correct, the service providing source 500 transmits the notice of service connection permission to the terminal 504 (S12). As a result, the terminal 504 becomes capable of using the service contents provided from the service providing source 500.

According to the application example described above, the card information (URL of the service providing source and user's identification information) and the owner information of the memory card 507 are stored in the IC chip 508 of the memory card 507 and are not stored in the terminal 504. Consequently, it is impossible to establish a connection to the service providing source 500 only with the terminal 504. As a result, it is possible to prevent the contents of the service providing source from being misused by another person due to loss or theft of the terminal 504.

Also, even when the memory card 507 is obtained by another person due to loss or theft, it is impossible for others to use the contents of the service providing source so long as the PIN authentication is not normally completed. As a result, unauthorized access to the service requesting source by another person and misuse of the service contents by others are prevented.

Further, the application 505 for accessing the service providing source, the URL of the service providing source 500, and the user's identification information are stored in the nonvolatile memory in the IC chip 508 built in the memory card 507. Therefore, even when the memory card 507 is attached to another terminal that is different from the terminal 504, it is possible to use the service contents of the service providing source 500 by following the same procedure.

Still further, with the function possessed by the IC chip 508, it is possible to perform secure data communication where the danger of data tampering, spoofing, or wiretapping is eliminated.

### EFFECTS PF THE EMBODIMENT

With the storage device (memory card) according to this embodiment, it is possible to use an IC chip built in the memory card using an information processing apparatus that has a memory card slot (memory card interface) and a control apparatus for the memory card. Accordingly, it is unnecessary to prepare a dedicated reader/writer for the IC chip. As a result, high portability and versatility are achieved.

Also, as a method of accessing the IC chip built in the memory card, an ordinary memory card access system is used. Therefore, it is unnecessary to incorporate a dedicated driver for accessing the IC chip into the information processing apparatus (terminal) side. Accordingly, by installing an application program for issuing a control command for the memory card for controlling the IC chip (application for creating data concerning a control command for the memory card in which a control command for the IC chip is mapped) on the information processing apparatus, it is possible to use the IC chip built in the memory card. Therefore, no alterations of the hardware of the information processing apparatus are required. As a result, improvements made in the embodiment are easy and simple.

With the storage device according to the present invention, it is possible to control a built-in IC chip using an already-existing control command for a storage device.

1. A storage device that is detachably attachable to an information processing apparatus, comprising:
an IC chip;
a first control unit extracting a control command for the IC chip included in a control command for the storage device from the information processing apparatus; and
a second control unit performing interface conversion corresponding to the IC chip on the control command for the IC chip extracted by the first control unit and giving the converted control command to the IC chip.

2. A storage device according to claim 1, wherein the second control unit performs interface conversion on data sent from the IC chip and stores the converted data in a predetermined storage area; and
the first control unit reads the data stored in the storage area in accordance with a control command for the storage device from the information processing apparatus and gives the read data to the information processing apparatus.

3. A storage device according to claim 1, wherein the first control unit receives a writing command for the storage apparatus, in whose data area a control command for the IC chip is mapped, and extracts the control command for the IC chip mapped in the data area.

4. A storage device according to claim 3, wherein the first control unit refers to an address area of the writing command for the storage device and, when an address is set therein which shows that the control command for the IC chip is mapped in the data area, extracts the control command for the IC chip from the data area.

5. A storage device according to any one of claims 1, wherein the IC chip comprises a nonvolatile memory and has a security function.

6. A storage device according to claim 2, wherein the first control unit receives a writing command for the storage apparatus, in whose data area a control command for the IC chip is mapped, and extracts the control command for the IC chip mapped in the data area.
